(19) United States
(12) Patent Application Publication
(10) Pub. No.: US 2025/0356506 A1
(43) Pub. Date: Nov. 20, 2025

(54) SEMANTIC VIDEO MOTION TRANSFER USING MOTION-TEXTUAL INVERSION

(71) Applicants: DISNEY ENTERPRISES, INC., Burbank, CA (US); ETH Zürich (Eidgenössische Technische Hochschule Zürich), Zürich (CH)

(72) Inventors: Manuel Jakob KANSY, Zürich (CH); Jacek Krzysztof NARUNIEC, Windlach (CH); Christopher Richard SCHROERS, Uster (CH); Romann Matthew WEBER, Uster (CH)

(21) Appl. No.: 19/210,425

(22) Filed: May 16, 2025

Related U.S. Application Data
(60) Provisional application No. 63/649,287, filed on May 17, 2024.

(51) Int. Cl. G06T 7/246; G06T 5/60; G06T 5/70; G06T 13/80

(52) U.S. Cl. CPC G06T 7/246; G06T 5/60; G06T 5/70; G06T 13/80; G06T 2207/10016; G06T 2207/20081

(57) ABSTRACT

One embodiment of the present invention sets forth a technique for performing motion transfer. The technique includes determining an embedding corresponding to a motion depicted in a first video. The technique also includes generating, via execution of a machine learning model based on the embedding and an appearance image, an output video that includes the motion depicted in the first video and an appearance depicted in the appearance image.

### CROSS-REFERENCE TO RELATED APPLICATIONS

This application claims the benefit of the U.S. Provisional Application titled “SEMANTIC VIDEO MOTION TRANSFER USING MOTION-TEXTUAL INVERSION,” filed on May 17, 2024, and having Ser. No. 63/649,287. The subject matter of this application is hereby incorporated herein by reference in its entirety.

### BACKGROUND

### Field of the Various Embodiments

The present invention relates generally to computer vision and machine learning and, more specifically, to semantic video motion transfer using motion-textual inversion.

### DESCRIPTION OF THE RELATED ART

Recent developments in machine learning and computer vision have led to significant improvements in the quality and functionality of video generation and editing techniques. For example, a diffusion model, which operates by iteratively converting random noise into new data such as images, can be trained to synthesize spatially and temporally coherent sequences of video frames. The diffusion model may operate as an image-to-video model that uses an image that acts as a starting or conditioning frame for the generation of the video and/or as a text-to-video model that uses a natural language description as input to produce a corresponding video. The diffusion model can also, or instead, be used to change the content, background, motion, and/or other attributes of an input video based on an input text prompt.

Existing techniques for generating and editing videos are typically unable to control both the appearance and motion in a video in a predictable and/or fine-grained manner. More specifically, the motion in a video generated by a conventional image-to-video diffusion model may be modified by altering the random seed used to generate random noise that is converted into the video and/or adjusting micro-conditioning inputs such as frame rate. Because neither approach is easily interpretable, it can be difficult to determine how the random seed and/or micro-conditioning inputs affect the motion in the video. Other techniques for controlling motion in output videos generated by image-to-video models tend to involve dense control inputs (e.g., motion vectors, depth maps, etc.) that require alignment between a target image from which the appearance of an output video is derived and a motion video that serves as a reference for the motion of the output video and/or manual control inputs (e.g., bounding boxes, trajectories, etc.) that involve significant effort for complex motions.

On the other hand, text-to-video models operate in the absence of a direct image input and consequently are unable to preserve the appearance and spatial layout of a target image. A text-to-image model may also, or instead, be fine-tuned on a motion reference video to better capture the corresponding motion but may also inadvertently learn the appearance of the motion reference video, which interferes with the ability of the text-to-image model to generalize to other appearances.

As the foregoing illustrates, what is needed in the art are more effective techniques for controlling motion in videos generated by machine learning models.

### SUMMARY

One embodiment of the present invention sets forth a technique for performing motion transfer. The technique includes determining an embedding corresponding to a motion depicted in a first video. The technique also includes generating, via execution of a machine learning model based on the embedding and an appearance image, an output video that includes the motion depicted in the first video and an appearance depicted in the appearance image.

One technical advantage of the disclosed techniques relative to the prior art is the ability to learn an embedding that encodes spatial and temporal attributes of motion in a given video. Accordingly, the embedding can be used to transfer the motion to an output video with a different appearance in a predictable and/or fine-grained manner without requiring additional control inputs such as bounding boxes and/or trajectories and/or fine-tuning the machine learning model. Another advantage of the disclosed techniques is the ability to specify specific attributes of the appearance of the output video via an appearance image. An additional technical advantage of the disclosed techniques is that, because the embedding does not include a spatial dimension, the output video can be generated from the embedding and appearance image without requiring objects in the motion reference video and appearance image to be spatially aligned. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the optimization engine and generation engine of FIG. 1, according to various embodiments.

FIG. 3A illustrates the example generation of spatial cross-attention maps and temporal cross-attention maps by a block in the image-to-video model of FIG. 2, according to various embodiments.

FIG. 3B illustrates how the spatial attention block and temporal attention block of FIG. 3A use spatial cross-attention maps and temporal cross-attention maps to process features, according to various embodiments.

FIG. 4A illustrates examples of different types of output generated by the generation engine of FIG. 1 using a motion reference video, according to various embodiments.

FIG. 4B illustrates examples of a motion reference video, appearance image, and corresponding output frames generated by the generation engine of FIG. 1 using the motion reference video and appearance image, according to various embodiments.

FIG. 5 is a flow diagram of method steps for performing semantic video motion transfer, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

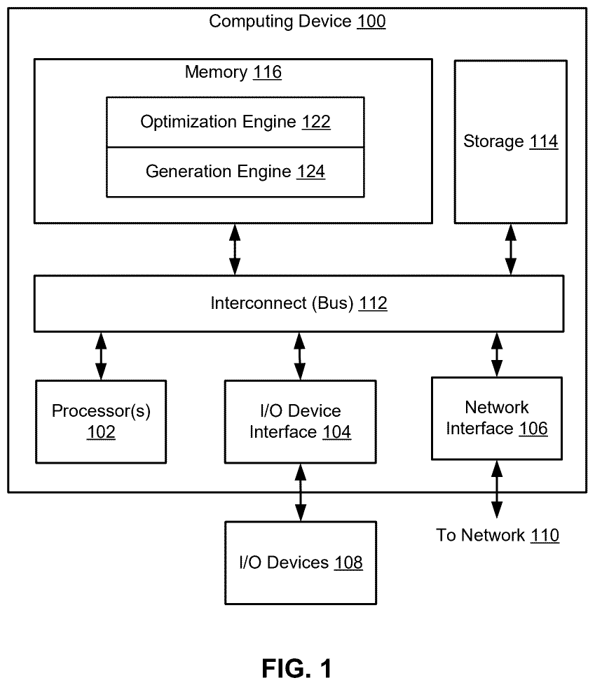

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an optimization engine 122 and a generation engine 124 that reside in memory 116.

It is noted that the computing device described herein is illustrative and that any other technically feasible configurations fall within the scope of the present disclosure. For example, multiple instances of optimization engine 122 and generation engine 124 may execute on a set of nodes in a distributed and/or cloud computing system to implement the functionality of computing device 100. In another example, optimization engine 122 and/or generation engine 124 may execute on various sets of hardware, types of devices, or environments to adapt optimization engine 122 and/or generation engine 124 to different use cases or applications. In a third example, optimization engine 122 and generation engine 124 may execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Optimization engine 122 and generation engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including optimization engine 122 and generation engine 124.

In one or more embodiments, optimization engine 122 and generation engine 124 include functionality to perform semantic motion video transfer, in which the semantics of a motion from a first “motion reference video” is transferred to a second video with a different appearance. Optimization engine 122 generates an embedding that captures the motion in the first video by optimizing the embedding based on a loss computed between an output video generated by a machine learning model (e.g., an image-to-video model) based on the embedding and the first video. The embedding may include multiple tokens for each frame of the first video and an additional set of tokens along a temporal dimension of the first video.

Generation engine 124 uses the machine learning model to generate the second video from the embedding and additional input (e.g., an appearance image that depicts an appearance to be incorporated into the second video, a set of noisy frames to be decoded into corresponding frames in the second video, etc.). For example, generation engine 124 may use one or more layers of the diffusion model to generate features corresponding to the additional input. Generation engine 124 may also use spatial and/or temporal cross-attention layers in the diffusion model to compute queries, keys, and values from the features and tokens. Generation engine 124 may also generate additional features using the queries, keys, and values and/or process the additional features and tokens using subsequent spatial and/or temporal cross-attention layers in the diffusion model. Generation engine 124 may repeat the process over a number of denoising steps using the diffusion model. Generation engine 124 may then decode a final set of features produced by the diffusion model into “pixel space” frames that are assembled into the second video. Optimization engine 122 and generation engine 124 are described in further detail below.

### Semantic Video Motion Transfer Using Motion-Textual Inversion

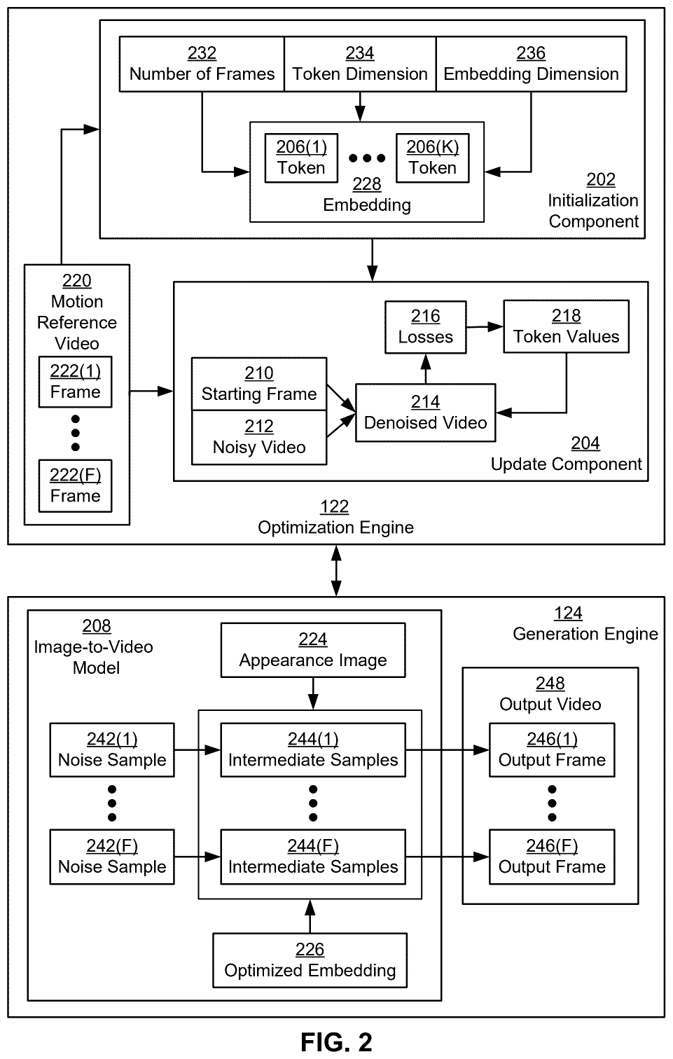

FIG. 2 is a more detailed illustration of optimization engine 122 and generation engine 124 of FIG. 1, according to various embodiments. As mentioned above, optimization engine 122 and generation engine 124 are configured to transfer the semantics of a motion from a motion reference video 220 to an output video 248 with a different appearance. Each of these components is described in further detail below.

In one or more embodiments, the semantic video motion transfer performed by optimization engine 122 and generation engine 124 can be represented by output video 248 that replicates the semantic motion of motion reference video 220 while preserving the appearance and spatial layout of target appearance image 224. Thus, the motion in output video 248 should match the semantics of motion reference video 220 instead of the spatial layout of objects in motion reference video 220. For example, output video 248 may depict a subject doing jumping jacks on the left or right side of output video 248, even when a corresponding subject in motion reference video 220 performs jumping jacks in the center of motion reference video 220.

Additionally, semantic video motion transfer can be performed using a pretrained image-to-video model 208, in which a sequence of output frames 246(1)-246 (N) (each of which is referred to individually herein as output frame 246) is generated from a given appearance image 224 (or set of images). For example, image-to-video model 208 may include a diffusion model that operates in pixel or latent space and is implemented using a U-Net and/or diffusion transformer (DiT). Image-to-video model 208 may also, or instead, include a generative adversarial network (GAN), variational encoder (VAE), and/or another type of generative machine learning model that is capable of generating a sequence of output frames 246 conditioned on an input appearance image 224 (or in an unconditional manner that does not depend on an input appearance image 224).

In some embodiments, image-to-video model 208 includes a diffusion model that is associated with a forward diffusion process, in which Gaussian noise ϵₜ˜ [symbol] (0,I) is added to a “clean” (e.g., without noise added) data sample x₀˜p_{data} (e.g., image, video frame, etc.) from a corresponding data distribution over a number of diffusion time steps t∈[1, T].

The diffusion model also includes a learnable denoiser (e.g., a neural network) D_{θ} that is trained to perform a denoising process that is the reverse of the forward diffusion process. Thus, the denoiser may iteratively remove noise from a pure noise sample x_{T} over t time steps to obtain a sample from the data distribution. The denoiser may be trained via denoising score matching:

$${𝔼}_{( {x}_{0} , c ) ∼ {p}_{data} ( {x}_{0} , c ) , ( σ , n ) ∼ p ( σ , n )} [ {λ}_{σ} {‖ {D}_{θ} ( {x}_{0} + n ; σ , c ) - {x}_{0} ‖}_{2}^{2} ] \qquad ( 1 )$$

In the above equation, c is a conditioning signal from the original data distribution p_{data}; p(σ, n)=p(σ) [symbol] (n; 0, σ²), where p(σ) is a probability distribution over noise levels σ; n is noise; and λ_{σ}: [symbol] ₊→ [symbol] ₊ is a weighting function.

The denoiser is parameterized as:

$${D}_{θ} ( x ; σ ) = {c}_{skip} ( σ ) x + {c}_{o u t} ( σ ) {F}_{θ} ( {c}_{i n} ( σ ) x ; {c}_{noise} ( σ ) ) \qquad ( 2 )$$

In the above equation, Fe is the neural network to be trained; cₛₖᵢₚ(σ) modulates the skip connection; cₒᵤₜ(σ) and cᵢₙ(σ) scale the output and input magnitudes respectively; and cₙₒᵢₛₑ(σ) maps noise level σ into a conditioning input for F_{θ}.

In some embodiments, the diffusion model includes a latent diffusion model that operates in a latent space instead of the “pixel space” of output frames 246. In the latent diffusion model, an encoder E produces a compressed latent z=ε(x), and the diffusion process is performed over z. A decoder [symbol] then reconstructs the latent features back into pixel space.

The diffusion model may further include a video latent diffusion model such as (but not limited to) Stable Video Diffusion (SVD). The SVD model may be trained in three stages. During the first stage, a text-to-image model is trained and/or fine-tuned on image-text pairs. During the second stage, the diffusion model is inflated by inserting temporal convolution and attention layers and trained on video-text pairs. In the third stage, the diffusion model is refined on a smaller subset of high-quality videos with exact model adaptations and inputs specific to a given task (e.g., text-to-video, image-to-video, frame interpolation, multi-view generation, etc.). For image-to-video generation, the task involves generating a video given the starting frame of the video. The starting frame may be supplied as a Contrastive Language-Image Pre-Training (CLIP) and/or another type of multimodal embedding via cross-attention, and as a latent that is repeated across frames and concatenated channel-wise to the video input. The SVD Model may also be micro-conditioned on frame rate, motion amount, and strength of noise augmentation applied to the latent of the first frame.

During normal operation of an SVD image-to-video model 208, input into image-to-video model 208 may include (i) a starting frame corresponding to appearance image 224 and (ii) a set of noise samples 242(1)-242(F) (each of which is referred to individually herein as noise sample 242) that are in a latent space and sampled from a Gaussian distribution. Image-to-video model 208 may generate an embedding 228 and/or a latent representation of appearance image 224. Image-to-video model 208 may also condition the iterative denoising of each noise sample into a series of intermediate samples 244(1)-244(F) (each of which is referred to individually herein as intermediate samples 244) in the latent space by applying the embedding using cross-attention layers and repeating the latent representation across frames and concatenating the latent representation channel-wise to noise samples 242. After the denoising process is complete, image-to-video model 208 may decode the final intermediate samples 244 in the latent space into corresponding output frames 246(1)-246(F) (each of which is referred to individually herein as output frame 246) that can be assembled into output video 248.

In one or more embodiments, optimization engine 122 and generation engine 124 perform semantic motion transfer by replacing the embedding of appearance image 224 that is used by image-to-video model 208 to generate intermediate samples 244 and output frames 246 with an optimized embedding 226 that reflects the motion in motion reference video 220. This optimized embedding 226 may be used by image-to-video model 208 to control the motion in output frames 246, while the latent representation of appearance image 224 may be used by image-to-video model 208 to control the appearance of output frames 246.

More specifically, optimization engine 122 learns optimized embedding 226 using motion reference video 220. As shown in FIG. 2, an initialization component 202 in optimization engine 122 initializes an embedding 228 that includes one or more tokens 206(1)-206(K) (each of which is referred to individually herein as token 206).

In one or more embodiments, embedding 228 includes a shape of (F+1)×N×d, where F is a certain number of frames 232 in motion reference video 220 (e.g., the length of motion reference video 220, a subset of F frames 222 from motion reference video 220, etc.), N is a token dimension 234 that represents the number of tokens 206 associated with each frame 222 of motion reference video 220, and d is an embedding dimension 236 that represents the length of each token 206. For example, F may be set to 14 for a 14-frame version of SVD, N may be set to 5 for each of the 14 frames 222, and d may be set to the CLIP embedding dimension 236 of 1024. Thus, initialization component 202 may generate (14+1)×5=75 tokens 206 during initialization of embedding 228, where each token 206 includes a vector with a length of 1024 to match the CLIP embedding dimension 236. The generated tokens 206 may include F sets of N tokens 206 that represent F frames 222 of motion reference video 220 and are used to represent spatial attributes of motion reference video 220. The generated tokens 206 may also include an additional set of N tokens 206 representing a temporal dimension of motion reference video 220.

Additionally, initialization component 202 may initialize tokens 206 in embedding 228 using a variety of token values 218. For example, initialization component 202 may initialize each of the F sets of N tokens 206 representing F frames 222 of motion reference video 220 with the CLIP embedding (or another type of embedding) of the corresponding frame 222. Initialization component 202 may also, or instead, initialize the N tokens 206 representing the temporal dimension of motion reference video 220 to the mean of CLIP embeddings (or other types of embeddings) across all frames 222 of motion reference video 220. Initialization component 202 may also, or instead, initialize various tokens 206 and/or subsets of tokens 206 in embedding 228 to random and/or other token values 218. Initialization component 202 may also, or instead, add Gaussian noise (e.g., [symbol] (0,0.1)) to token values 218 during initialization of tokens 206.

An update component 204 in optimization engine 122 iteratively updates token values 218 of tokens 206 using motion reference video 220. As shown in FIG. 2, update component 204 uses image-to-video model 208 to generate a denoised video 214 from current token values 218 of tokens 206 in embedding 228, a starting frame 210 of motion reference video 220, and a noisy video 212 corresponding to motion reference video 220. For example, update component 204 may input, into an SVD and/or another type of image-to-video model 208, (i) starting frame 210 that is repeated across F number of frames 232 and (ii) noisy video 212 xₜ, which can be generated by applying a set of spatial and/or color augmentations to F frames 222 of motion reference video 220 and adding random noise to the augmented frames 222 according to a noise schedule associated with time step t. The noise schedule may be shifted toward higher noise values (e.g., Pₘₑₐₙ=2.8, P_{std}=1.6 where log σ= [symbol] (Pₘₑₐₙ, Pₛₜₐ²)). Update component 204 may also input token values 218 of tokens 206 in embedding 228 into image-to-video model 208 (e.g., via cross-attention layers in image-to-video model 208). Update component 204 may additionally use image-to-video model 208 to denoise noisy video 212 based on starting frame 210 and token values 218, resulting in a corresponding denoised video 214.

Update component 204 also computes one or more losses 216 using denoised video 214 and motion reference video 220 and optimizes token values 218 of tokens 206 based on losses 216. For example, update component 204 may compute a denoising score matching loss between frames in denoised video 214 and corresponding frames 222 in motion reference video 220:

$${m}^{*} = {arg min}_{m} {𝔼}_{( {x}_{0} , c ) ∼ {p}_{data} ( {x}_{0} , c ) , ( σ , n ) ∼ p ( σ , n )} [ {λ}_{σ} {‖ {D}_{θ} ( {x}_{0} + n ; σ , m , c ) - {x}_{0} ‖}_{2}^{2} ] \qquad ( 3 )$$

In the above equation, c encompasses all remaining conditionings of SVD (e.g., first frame latent, time/noise step, micro-conditionings, etc.). Update component 204 may additionally use an optimization technique (e.g., Adam with a learning rate of 10⁻² for 1000 iterations with a batch size of 1) to update token values 218 based on gradients associated with losses 216 (e.g., while keeping the parameters of image-to-video model 208 frozen). Update component 204 may continue using the optimization technique to generate a new denoised video 214 using the updated token values 218, compute a corresponding set of losses 216, and update token values 218 based on losses 216 until a certain number of iterations has been performed, losses 216 converge and/or fall below a threshold, and/or another condition is met.

After optimization of token values 218 in embedding 228 is complete, optimization engine 122 populates optimized embedding 226 with the optimized token values 218. Generation engine 124 then uses optimized embedding 226 in lieu of the embedding of appearance image 224 to generate output frames 246 of output video 248 that incorporate the motion in motion reference video 220.

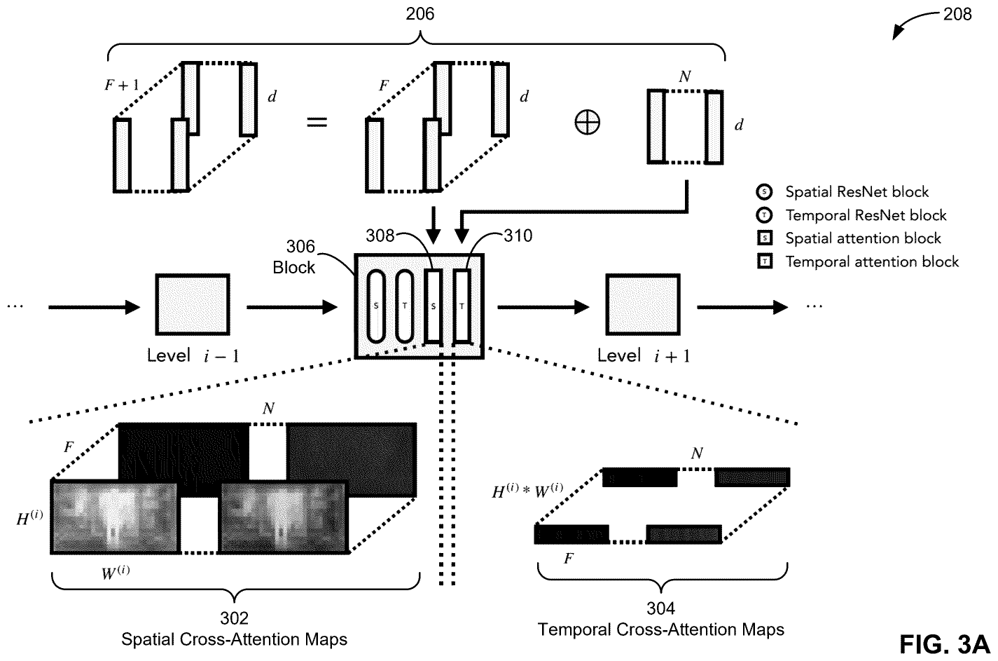

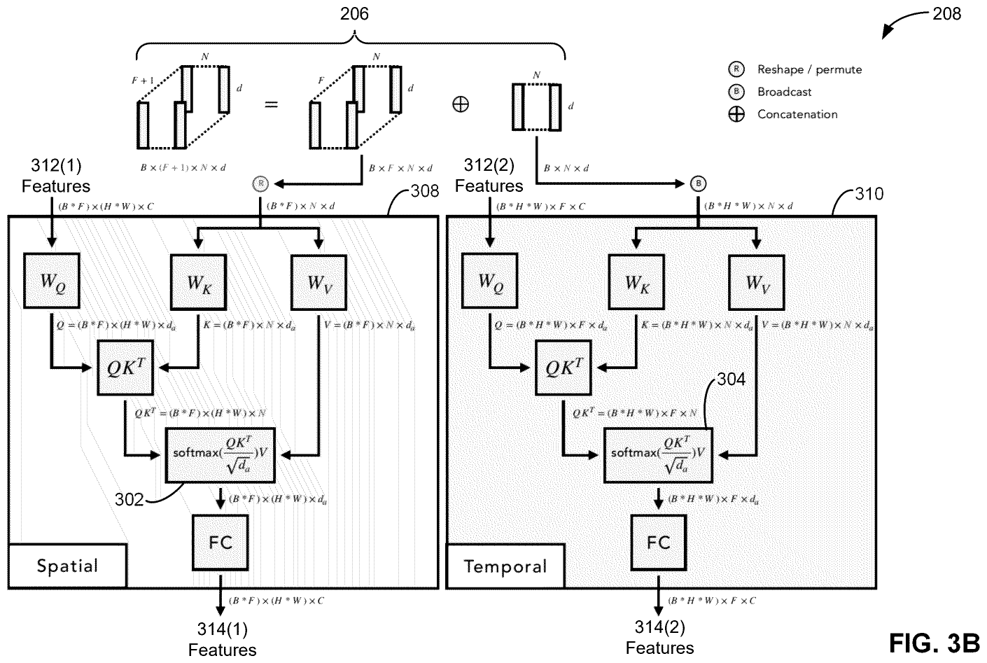

In one or more embodiments, generation engine 124 uses different sets of tokens 206 in optimized embedding 226 with spatial and temporal cross-attention layers of image-to-video model 208 to allow image-to-video model 208 to attend to different spatial and temporal locations associated with motion reference video 220 and/or output video 248. This use of different sets of tokens 206 with spatial and temporal cross-attention layers of image-to-video model 208 is described in further detail below with respect to FIG. 3A-3B.

FIG. 3A illustrates the example generation of spatial cross-attention maps 302 and temporal cross-attention maps 304 by a block 306 in image-to-video model 208 of FIG. 2, according to various embodiments. As shown in FIG. 3A, block 306 is associated with level i in image-to-video model 208. For example, block 306 may be included in the ith level of a U-Net based SVD model. A similar block may be included in the preceding level (e.g., i−1) of image-to-video model 208 and/or a succeeding level (e.g., i+1) of image-to-video model 208. Features outputted by a given level of image-to-video model 208 are used as input into the next level of image-to-video model 208.

Block 306 includes a spatial ResNet block, a temporal ResNet block, a spatial attention block 308, and a temporal attention block 310. Spatial attention block 308 uses F×N tokens 206 representing F frames 222 of motion reference video 220 to compute F sets of N spatial cross-attention maps 302. Each spatial cross-attention map has dimensions of H⁽ⁱ⁾×W⁽ⁱ⁾, where H⁽ⁱ⁾ and W⁽ⁱ⁾ are the spatial heights and widths associated with level i. Each set of N spatial cross-attention maps 302 is also associated with a different frame 222 of motion reference video 220.

Because spatial cross-attention maps 302 are generated using a different set of tokens 206 for each frame 222, spatial attention block 308 can be used to attend to different aspects of individual frames 222 and/or across frames 222. For example, spatial attention block 308 may use different sets of tokens 206 across all frames 222, resulting in different sets of keys and values for each frame. Different keys allow image-to-video model 208 to attend to different spatial locations for different frames 222 (e.g., the arm of a person in one frame 222 and the leg of the person in another frame 222). Different values allow image-to-video model 208 to apply different changes to features associated with different frames 222 (e.g., shift pixels in one direction for one frame 222 and in a different direction for a different frame 222). Further, different spatial cross-attention maps 302 for the same frame 222 may be used to attend to different tokens depending on the corresponding features (e.g., using different values for the foreground and background of a given frame 222).

Temporal attention block 310 uses a different set of N tokens 206 representing the temporal dimension of motion reference video 220 to compute H⁽ⁱ⁾*W⁽ⁱ⁾ sets of N temporal cross-attention maps 304. Each temporal cross-attention map has dimensions of F, and each set of N temporal cross-attention maps 304 is associated with a different spatial location of motion reference video 220. Thus, each temporal cross-attention map identifies which frame should be considered most for a given pixel. This set of N tokens 206 may be used across all spatial locations in frames 222 by temporal attention block 310 and can be used to perform temporal alignment with motion reference video 220.

FIG. 3B illustrates how spatial attention block 308 and temporal attention block 310 of FIG. 3A use spatial cross-attention maps 302 and temporal cross-attention maps 304 to process features 312(1)-312(2), according to various embodiments. More specifically, spatial attention block 308 receives, as input, a first set of features 312(1) and B×F×N tokens 206 (where B is a batch size that can be set to 1 during optimization of tokens 206 and 2 during inference due to classifier-free guidance) representing F frames 222 of motion reference video 220 and outputs a second set of features 314(1). Temporal attention block 310 receives, as input, a third set of features 312(2) and B×N tokens 206 representing the temporal dimension of motion reference video 220 and outputs a fourth set of features 314(2).

In some embodiments, each of spatial attention block 308 and temporal attention block 310 compute cross-attention using the following:

$$\begin{matrix}Attention ( Q , K , V ) = MV = softmax ( \frac{Q {K}^{T}}{\sqrt{{d}_{a}}} ) V \\ Q = {φ}_{i} ( {z}_{t} ) {W}_{Q , i} , K = m {W}_{K , i} , V = m {W}_{V , i}\end{matrix} \qquad ( 3 )$$

In the above equation, Q, K, V are queries, keys, and values respectively,

$$M = softmax ( \frac{Q {K}^{T}}{\sqrt{{d}_{a}}} )$$

is an attention map (e.g., from spatial cross-attention maps 302 or temporal cross attention maps 304); dₐ is the dimension used in the attention operation; φᵢ(zₜ) is an intermediate representation of the level i features (e.g., features 312(1) or 312(2)) with Cᵢ channels; m is an embedding (e.g., embedding 228 and/or optimized embedding 226) with embedding dimension d; and W_{Q,i}∈ [symbol] ^{C}^{ᵢ}^{×d}^{ₐ}, W_{K,i}∈ [symbol] ^{d×d}^{ₐ}, and W_{V,i}∈ [symbol] ^{d×d}^{ₐ} are learned weight matrices for queries, keys, and values respectively.

After cross-attention is computed by spatial attention block 308 (e.g., from features 312(1) and B×F×N tokens 206) or temporal attention block 310 (e.g., from features 312(2) and B×N tokens 206), the result is processed by a fully connected (FC) layer in the same block to produce a corresponding set of features 314(1) or 314(2). Features 314(1) and 314(2) can then be used as input into the next level of image-to-video model 208.

By increasing the number of tokens 206 used in spatial and temporal cross-attention layers of image-to-video model 208, the disclosed techniques improve the ability of image-to-video model 208 to control motion in output video 248. More specifically, a conventional SVD model uses an image embedding that includes a single token with dimensions B×F×d. This token is broadcast across all frames using spatial cross-attention to dimensions (B*F)×1×d, resulting in an attention map of dimensions (B*F)×(H⁽ⁱ⁾*W⁽ⁱ⁾)×1 and the same value of 1 for every location in the attention map. Similarly, for temporal cross-attention, the token is broadcast across all spatial locations from dimensions of B×1×d to dimensions (B*H⁽ⁱ⁾*W⁽ⁱ⁾)×1×d, resulting in an attention map of dimensions (B*H⁽ⁱ⁾*W⁽ⁱ⁾)×F×1 where every value is also 1. Having one token in the image embedding thus leads to a degenerate case where Attention (Q, K, V)=V and the queries and keys have no effect on the result.

On the other hand, an extension of token dimension 234 from 1 to N (where N>1) results in a spatial cross-attention map M of dimensions (B*F)×(H⁽ⁱ⁾*W⁽ⁱ⁾)×N that includes different values that are not equal to 1 for the N different tokens 206. Similarly, the temporal cross-attention map includes dimensions of (B*H⁽ⁱ⁾*W⁽ⁱ⁾)×F×N and values that are not equal to 1. Thus, both spatial cross-attention maps 302 and temporal cross-attention maps 304 can be used to attend to different tokens 206, spatial features 312(1), and/or temporal features 312(2) within image-to-video model 208.

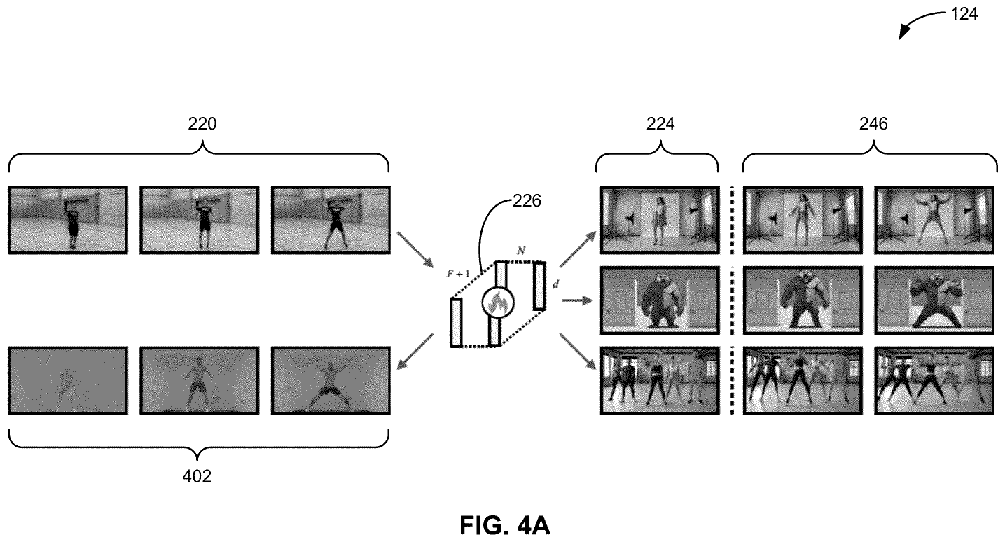

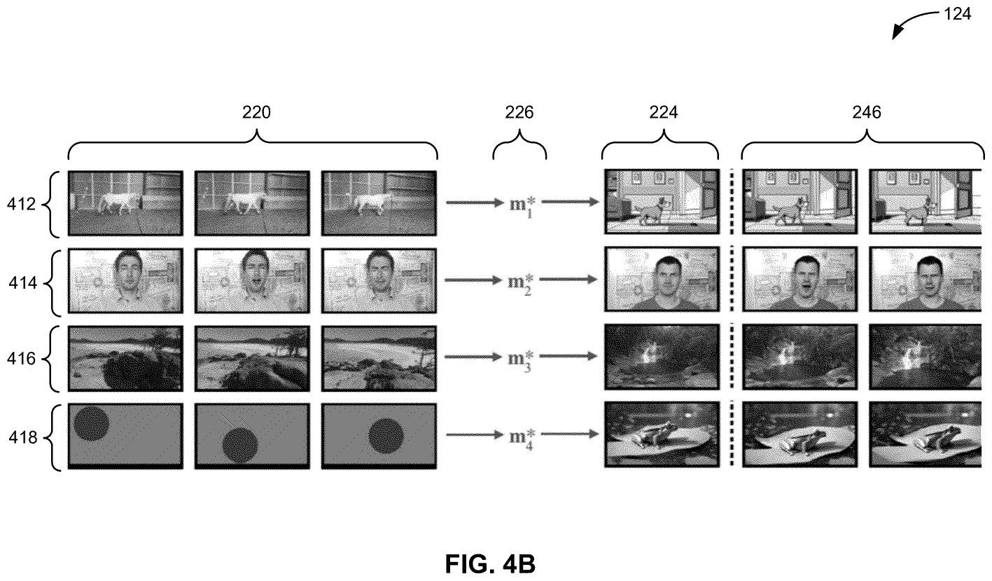

FIG. 4A illustrates different types of output generated by generation engine 124 of FIG. 1 using an example motion reference video 220, according to various embodiments. As shown in FIG. 4A, the example motion reference video 220 depicts a person performing jumping jacks. This motion reference video 220 may be used to generate a corresponding optimized embedding 226 using the techniques discussed above. This optimized embedding 226 can then be used by a diffusion model with an unconditional latent input (e.g., all zeros) and/or a lack of appearance image 224 to generate a motion visualization 402 that includes the same jumping jack motion and an unconditional appearance. This optimized embedding 226 can also be input into a conditional diffusion model with a corresponding appearance image 224 to generate output frames 246 that include the appearance from appearance image 224 and the jumping jack motion from motion reference video 220.

Further, the representation of motion in optimized embedding 226 allows for semantic motion transfer under different conditions. These conditions include a lack of spatial alignment between the person in motion reference video 220 and a different person in the top-row appearance image 224; different domains associated with motion reference video 220 and the middle-row appearance image 224; and multiple objects in the bottom-row appearance image 224.

FIG. 4B illustrates examples 412, 414, 416, and 418 of motion reference video 220, appearance image 224, and corresponding output frames 246 generated by generation engine 124 of FIG. 1 using motion reference video 220 and appearance image 224, according to various embodiments. As shown in FIG. 4B, example 412 includes a first motion reference video 220 that depicts a full-body motion (e.g., a horse trotting). This motion reference video is used to generate a corresponding optimized embedding 226 denoted by mt. This optimized embedding 226 and a first appearance image 224 of a cartoon dog are used by image-to-video model 208 to generate output frames 246 that depict the cartoon dog performing the same full-body motion from the first motion reference video 220.

Example 414 includes a second motion reference video 220 that depicts a facial motion (e.g., yawning) performed by a first face. This motion reference video is used to generate a corresponding optimized embedding 226 denoted by m₂^{*}. This optimized embedding 226 and a second appearance image 224 depicting a second face are used by image-to-video model 208 to generate output frames 246 that show the second face performing the same facial motion from the first motion reference video 220.

Example 416 includes a third motion reference video 220 that depicts camera motion (e.g., as a camera moves in a forward direction over a first scene). This motion reference video is used to generate a corresponding optimized embedding 226 denoted by m₃^{*}. This optimized embedding 226 and a third appearance image 224 of a second scene are used by image-to-video model 208 to generate output frames 246 that depict the same camera motion with respect to the second scene.

Example 418 includes a fourth motion reference video 220 that depicts a hand-crafted motion in a first object (e.g., a circle moving within the frame). This motion reference video is used to generate a corresponding optimized embedding 226 denoted by ma. This optimized embedding 226 and a fourth appearance image 224 of a second object (e.g., a frog on a lily pad) are used by image-to-video model 208 to generate output frames 246 that depict the hand-crafted motion applied to the second object.

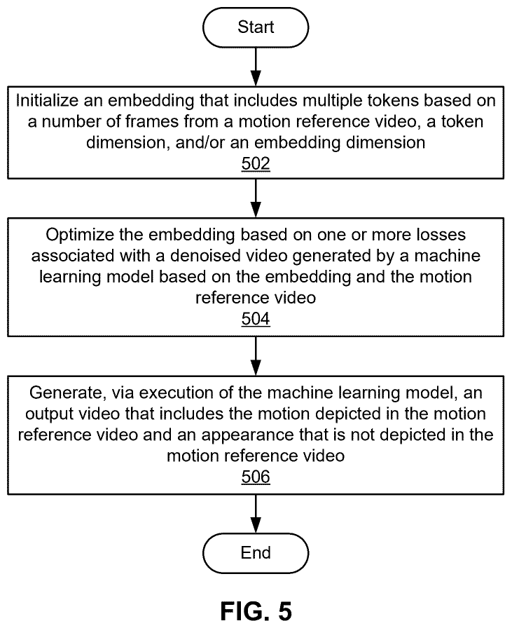

FIG. 5 is a flow diagram of method steps for performing semantic video motion transfer, according to various embodiments. Although the method steps are described in conjunction with the systems of FIGS. 1-2, persons skilled in the art will understand that any system configured to perform some or all of the method steps in any order falls within the scope of the present disclosure.

As shown, in step 502, optimization engine 122 initializes an embedding that includes multiple tokens based on a number of frames from a motion reference video, a token dimension, and/or an embedding dimension. For example, optimization engine 122 may populate the embedding with (F+1)×N×d tokens, where F is a certain number of frames in the motion reference video 220, N is the token dimension that represents the number of tokens associated with each frame of the motion reference video, and d is the embedding dimension that represents the length of each token. Optimization engine 122 may initialize token values of the tokens using CLIP embeddings of frames in the motion reference video, Gaussian noise, and/or other values.

In step 504, optimization engine 122 optimizes the embedding based on one or more losses associated with a denoised video generated by a machine learning model based on the embedding and the motion reference video. For example, optimization engine 122 may input the embedding, a starting frame of the motion reference video, and noisy versions of frames in the motion reference video into an SVD model and/or another type of image-to-video model. Optimization engine 122 may use the image-to-video model to generate the denoised video from the input and compute a denoising score matching loss (or another type of loss) between the denoised video and the motion reference video. Optimization engine 122 may also iteratively update token values of the tokens in the embedding based on the loss(es) until a certain number of optimization steps has been performed, the loss(es) fall below a threshold, and/or another condition is met.

In step 506, generation engine 124 generates, via execution of the machine learning model, an output video that includes the motion depicted in the motion reference video and an appearance that is not depicted in the motion reference video. For example, generation engine 124 may input the optimized embedding, a set of noise samples corresponding to a set of frames in the output video, and an optional appearance image into the image-to-video model. Generation engine 124 may use spatial and temporal cross-attention layers in the image-to-video model to compute attention maps and values from different subsets of tokens in the optimized embedding and features generated by preceding layers in the image-to-video model. Generation engine 124 may also use the image-to-video model to generate additional features from the attention maps and values. Generation engine 124 may additionally denoise the noise samples over a number of denoising steps based on the additional features and generate output frames in the output video using the resulting denoised samples. The output video may include motion that is semantically similar to the motion in the motion reference video and an appearance that is derived from the appearance image (if the appearance image is provided) and/or based on a seed used to generate the noise samples.

In sum, the disclosed techniques perform semantic video motion transfer, in which the motion from a first “motion reference video” is transferred to a second video with a different appearance. An embedding that captures the motion in the first video is determined by optimizing the embedding based on a loss computed between an output video generated by a machine learning model (e.g., an image-to-video model) based on the embedding and the first video. The embedding may include multiple tokens for each frame of the first video and an additional set of tokens along a temporal dimension of the first video. The embedding and additional features associated with an appearance image and/or a set of noisy frames are processed by spatial and temporal cross-attention layers in the diffusion model to generate one or more additional sets of features. At least some of these additional features are used to generate output frames that are assembled into the second video.

One technical advantage of the disclosed techniques relative to the prior art is the ability to learn an embedding that encodes spatial and temporal attributes of motion in a given video. Accordingly, the embedding can be used to transfer the motion to an output video with a different appearance in a predictable and/or fine-grained manner without requiring additional control inputs such as bounding boxes and/or trajectories and/or fine-tuning the machine learning model. Another advantage of the disclosed techniques is the ability to specify specific attributes of the appearance of the output video via an appearance image. An additional technical advantage of the disclosed techniques is that, because the embedding does not include a spatial dimension, the output video can be generated from the embedding and appearance image without requiring objects in the motion reference video and appearance image to be spatially aligned. These technical advantages provide one or more technological improvements over prior art approaches.

1. In some embodiments, a computer-implemented method for performing motion transfer comprises determining an embedding corresponding to a motion depicted in a first video; and generating, via execution of a machine learning model based on the embedding and an appearance image, an output video that includes the motion depicted in the first video and an appearance depicted in the appearance image.

2. The computer-implemented method of clause 1, wherein determining the embedding comprises initializing the embedding based on at least a portion of the first video; and updating the embedding based on one or more losses associated with an additional output video generated by the machine learning model based on the embedding.

3. The computer-implemented method of any of clauses 1-2, wherein the embedding is initialized based on one or more embeddings of one or more frames in the first video.

4. The computer-implemented method of any of clauses 1-3, wherein the one or more losses are computed based on the additional output video and the first video.

5. The computer-implemented method of any of clauses 1-4, wherein determining the embedding comprises generating a plurality of tokens corresponding to the embedding based on the first video.

6. The computer-implemented method of any of clauses 1-5, wherein generating the output video comprises generating one or more attention maps and one or more sets of values based on the plurality of tokens; computing one or more sets of features based on the one or more attention maps and the one or more sets of values; and generating the output video based on the one or more sets of features.

7. The computer-implemented method of any of clauses 1-6, wherein the one or more attention maps are generated via a spatial attention block and a temporal attention block included in the machine learning model.

8. The computer-implemented method of any of clauses 1-7, wherein the plurality of tokens comprises a different set of tokens for each frame in the first video.

9. The computer-implemented method of any of clauses 1-8, wherein the plurality of tokens comprises a set of tokens associated with a temporal dimension of the first video.

10. The computer-implemented method of any of clauses 1-9, wherein the machine learning model comprises a diffusion model.

11. In some embodiments, one or more non-transitory computer-readable media store instructions that, when executed by one or more processors, cause the one or more processors to perform the steps of determining an embedding corresponding to a motion depicted in a first video; and generating, via execution of a machine learning model based on the embedding and an appearance image, an output video that includes the motion depicted in the first video and an appearance depicted in the appearance image.

12. The one or more non-transitory computer-readable media of clause 11, wherein determining the embedding comprises initializing the embedding based on at least a portion of the first video; and iteratively updating the embedding based on one or more losses associated with an additional output video generated by the machine learning model based on the embedding.

13. The one or more non-transitory computer-readable media of any of clauses 11-12, wherein the embedding is initialized based on one or more embeddings of one or more frames in the first video and Gaussian noise.

14. The one or more non-transitory computer-readable media of any of clauses 11-13, wherein the one or more losses comprise a denoising score matching loss.

15. The one or more non-transitory computer-readable media of any of clauses 11-14, wherein the additional output video is further generated by the machine learning model based on a starting frame in the first video and a noisy version of the first video.

16. The one or more non-transitory computer-readable media of any of clauses 11-15, wherein determining the embedding comprises generating a plurality of tokens corresponding to the embedding based on the first video, wherein the plurality of tokens comprises (i) a different set of tokens for each frame in the first video and (ii) an additional set of tokens associated with a temporal dimension of the first video.

17. The one or more non-transitory computer-readable media of any of clauses 11-16, wherein generating the output video comprises generating a set of spatial cross-attention maps and a first set of values based on the different set of tokens for each frame in the first video; generating a set of temporal cross-attention maps and a second set of values based on the additional set of tokens associated with the temporal dimension of the first video; computing one or more sets of features based on the set of spatial cross-attention maps, the first set of values, the set of temporal cross-attention maps, and the second set of values; and generating the output video based on the one or more sets of features.

18. The one or more non-transitory computer-readable media of any of clauses 11-17, wherein the output video is further generated based on a plurality of noisy frames.

19. The one or more non-transitory computer-readable media of any of clauses 11-18, wherein the machine learning model comprises an image-to-video model.

20. In some embodiments, a system comprises one or more memories that store instructions, and one or more processors that are coupled to the one or more memories and, when executing the instructions, are configured to perform the steps of determining an embedding corresponding to a motion depicted in a first video; and generating, via execution of a machine learning model based on the embedding, an output video that includes the motion depicted in the first video and an appearance that is not depicted in the first video.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing motion transfer, the method comprising:
determining an embedding corresponding to a motion depicted in a first video; and
generating, via execution of a machine learning model based on the embedding and an appearance image, an output video that includes the motion depicted in the first video and an appearance depicted in the appearance image.

2. The computer-implemented method of claim 1, wherein determining the embedding comprises:
initializing the embedding based on at least a portion of the first video; and
updating the embedding based on one or more losses associated with an additional output video generated by the machine learning model based on the embedding.

3. The computer-implemented method of claim 2, wherein the embedding is initialized based on one or more embeddings of one or more frames in the first video.

4. The computer-implemented method of claim 2, wherein the one or more losses are computed based on the additional output video and the first video.

5. The computer-implemented method of claim 1, wherein determining the embedding comprises generating a plurality of tokens corresponding to the embedding based on the first video.

6. The computer-implemented method of claim 5, wherein generating the output video comprises:
generating one or more attention maps and one or more sets of values based on the plurality of tokens;
computing one or more sets of features based on the one or more attention maps and the one or more sets of values; and
generating the output video based on the one or more sets of features.

7. The computer-implemented method of claim 6, wherein the one or more attention maps are generated via a spatial attention block and a temporal attention block included in the machine learning model.

8. The computer-implemented method of claim 5, wherein the plurality of tokens comprises a different set of tokens for each frame in the first video.

9. The computer-implemented method of claim 5, wherein the plurality of tokens comprises a set of tokens associated with a temporal dimension of the first video.

10. The computer-implemented method of claim 1, wherein the machine learning model comprises a diffusion model.

11. One or more non-transitory computer-readable media storing instructions that, when executed by one or more processors, cause the one or more processors to perform the steps of:
determining an embedding corresponding to a motion depicted in a first video; and
generating, via execution of a machine learning model based on the embedding and an appearance image, an output video that includes the motion depicted in the first video and an appearance depicted in the appearance image.

12. The one or more non-transitory computer-readable media of claim 11, wherein determining the embedding comprises:
initializing the embedding based on at least a portion of the first video; and
iteratively updating the embedding based on one or more losses associated with an additional output video generated by the machine learning model based on the embedding.

13. The one or more non-transitory computer-readable media of claim 12, wherein the embedding is initialized based on one or more embeddings of one or more frames in the first video and Gaussian noise.

14. The one or more non-transitory computer-readable media of claim 12, wherein the one or more losses comprise a denoising score matching loss.

15. The one or more non-transitory computer-readable media of claim 12, wherein the additional output video is further generated by the machine learning model based on a starting frame in the first video and a noisy version of the first video.

16. The one or more non-transitory computer-readable media of claim 11, wherein determining the embedding comprises generating a plurality of tokens corresponding to the embedding based on the first video, wherein the plurality of tokens comprises (i) a different set of tokens for each frame in the first video and (ii) an additional set of tokens associated with a temporal dimension of the first video.

17. The one or more non-transitory computer-readable media of claim 16, wherein generating the output video comprises:
generating a set of spatial cross-attention maps and a first set of values based on the different set of tokens for each frame in the first video;
generating a set of temporal cross-attention maps and a second set of values based on the additional set of tokens associated with the temporal dimension of the first video;
computing one or more sets of features based on the set of spatial cross-attention maps, the first set of values, the set of temporal cross-attention maps, and the second set of values; and
generating the output video based on the one or more sets of features.

18. The one or more non-transitory computer-readable media of claim 11, wherein the output video is further generated based on a plurality of noisy frames.

19. The one or more non-transitory computer-readable media of claim 11, wherein the machine learning model comprises an image-to-video model.

20. A system, comprising:
one or more memories that store instructions, and
one or more processors that are coupled to the one or more memories and, when executing the instructions, are configured to perform the steps of:
determining an embedding corresponding to a motion depicted in a first video; and
generating, via execution of a machine learning model based on the embedding, an output video that includes the motion depicted in the first video and an appearance that is not depicted in the first video.
